(19) United States
(12) Patent Application Publication
(10) Pub. No.: US 2020/0081939 A1
(43) Pub. Date: Mar. 12, 2020

(54) SYSTEM FOR OPTIMIZING DETECTION OF INTENT[S] BY AUTOMATED CONVERSATIONAL BOT[S] FOR PROVIDING HUMAN LIKE RESPONSES

(71) Applicant: HCL Technologies Limited, Noida (IN)

(72) Inventor: Senthil Kumar SUBRAMANIAM, Sunnyvale, CA (US)

(21) Appl. No.: 16/258,680

(22) Filed: Jan. 28, 2019

(30) Foreign Application Priority Data
Sep. 11, 2018 (IN) 201811034198

(51) Int. Cl. G06F 17/21; G06F 17/27; G10L 15/22; G06F 16/9032; G06F 16/901; G06F 16/29; G10L 15/30; G06N 20/00

(52) U.S. Cl. CPC G06F 17/21; G06F 17/27; G10L 15/22; G06N 20/00; G06F 16/9024; G06F 16/29; G10L 15/30; G06F 16/90332

(57) ABSTRACT

Disclosed is a system for optimizing detection of an intent, pertaining to a query, by an automated conversational bot for providing human like responses to a user. An analyzer module builds an intent graph storing input dialogues, utterances, and output dialogues associated to an intent. A builder module fed training data, comprising the intent graph stored in the graph database to an automated conversational bot by enabling a bot builder to fill a bot template associated to each intent with a set of parameters indicating distinct utterances of an intent and output dialogues associated to the distinct utterances. A verification module trains the automated conversational bot through reinforcement learning by providing a feedback to the automated conversational bot. In one aspect, the automated conversational bot may be trained by validating an output dialogue against an input dialogue, received from the caller, with an expected response.

### CROSS REFERENCE TO RELATED APPLICATIONS

The present application claims benefit from Indian Complete Patent Application No. 201811034198 filed on 11 Sep. 2018 the entirety of which is hereby incorporated by reference.

### TECHNICAL FIELD

The present subject matter described herein, in general, relates to a method and system for detecting an intent by an automated conversational bot for providing human like responses. More specifically, the method and system for providing the human like responses upon feeding a call recording archive.

### BACKGROUND

For the last couple of decades, enterprises are using telephone based contact centers to provide support to their customers. A customer service representative answers the phone call of a customer and provides required information or action in a friendly manner aligned to the region and culture. It may be noted that all such calls are recorded for training and quality analysis purposes.

In the last few years, due to the advent of Artificial Intelligence (AI) using Machine Learning, the enterprises are moving towards automated conversational Voice/Chat based bots that have capabilities to answer the queries of the customer. According to a recent report by Grand View Research, the global Bot market is expected to reach S1.23 billion by 2025. These AI based Voice/Chat bots are not like the legacy Interactive Voice Response (IVR) applications built using scripting languages such as Voice XML, where the customer has to go through a menu and select a specific input from a keypad in order to choose an intent. Instead, the AI based Voice/Chat bots have Natural Language Processing (NLP) capabilities that may help in detecting the intent.

Though the AI based Voice/Chat bots may detect the intent, the intent detection by the AI based Voice/Chat bots may be limited various input variations and utterances that were configured by a developer during the bot building phase. In other words, the aforementioned approach for detecting the intent is limited to possible intent combinations and appropriate responses as the developer cannot think of all possible utterances during the building of the AI based Voice/Chat bots.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for optimizing detection of an intent, pertaining to a query, by an automated conversational bot for providing human like responses to a user and the concepts are further described below in the detailed description. This summary is not intended to identify essential features of the claimed subject matter nor is it intended for use in limiting the scope of the claimed subject matter.

In one implementation, a system for optimizing detection of an intent, pertaining to a query, by an automated conversational bot for providing human like responses to a user is disclosed. The system may comprise a processor and a memory coupled to the processor. The processor may execute a plurality of modules present in the memory. The plurality of modules may comprise an analyzer module, an extraction module, a builder module, and a verification module. The analyzer module may build an intent graph storing input dialogues, utterances, and output dialogues associated to an intent. In one aspect, the intent may indicate a context of a conversation between a caller and a call center representative. In order to build the intent graph, the extraction module may feed each audio file indicating a call recording, present in a call recording archive, to a Natural Language Processing (NLP) engine to create a set of raw text transcripts pertaining to a category. The extraction module may further determine a plurality of intents from the set of raw text transcripts upon identifying one or more NLP entities from words present in the set of raw text transcripts. In one aspect, each intent may be associated to at least one category. The extraction module may further map the input dialogues, the utterances, and the output dialogues with each intent, of the plurality of intents thereby building the intent graph pertaining to each intent. The builder module may feed training data, comprising the intent graph stored in the graph database, to an automated conversational bot by enabling a bot builder to fill a bot template associated to each intent with a set of parameters indicating distinct utterances of an intent and output dialogues associated to the distinct utterances. The verification module may train the automated conversational bot through reinforcement learning by providing a feedback to the automated conversational bot. In one aspect, the automated conversational bot may be trained by validating an output dialogue against an input dialogue, received from the caller, with an expected response. The output dialogue may be provided by the automated conversational bot based on the bot template and the training data thereby optimizing detection of the intent of a query by the automated conversational bot for providing human like responses to the user based on the call recording archive.

In another implementation, a method for optimizing detection of an intent, pertaining to a query, by an automated conversational bot for providing human like responses to a user is disclosed. In order to optimize detection of the intent, initially, an intent graph storing input dialogues, utterances, and output dialogues associated to an intent may be built. In one aspect, the intent may indicate a context of a conversation between a caller and a call center representative. In one aspect, the intent graph is built by feeding each audio file indicating a call recording, present in a call recording archive, to a Natural Language Processing (NLP) engine in order to create a set of raw text transcripts pertaining to a category. Upon feeding each audio file, a plurality of intents may be determined from the set of raw text transcripts upon identifying one or more NLP entities from words present in the set of raw text transcripts. In one aspect, each intent may be associated to at least one category. Subsequent to the determination of the plurality of intents, the input dialogues, the utterances, and the output dialogues may be mapped with each intent, of the plurality of intents thereby building the intent graph pertaining to each intent. Post building the intent graph, training data may be fed to an automated conversational bot by enabling a bot builder in order to fill a bot template associated to each intent with a set of parameters indicating distinct utterances of an intent and output dialogues associated to the distinct utterances. In one aspect, the training data may comprise the intent graph stored in the graph database. Upon feeding the training data, the automated conversational bot may be trained through reinforcement learning by providing a feedback to the automated conversational bot. In one aspect, the automated conversational bot may be trained by validating an output dialogue against an input dialogue, received from the caller, with an expected response, wherein the output dialogue is provided by the automated conversational bot based on the bot template and the training data thereby optimizing detection of the intent of a query by the automated conversational bot for providing human like responses to the user based on the call recording archive. In one aspect, the aforementioned method for optimizing detection of the intent by the automated conversational bot may be performed by a processor using programmed instructions stored in a memory of the system.

In yet another implementation, non-transitory computer readable medium embodying a program executable in a computing device for optimizing detection of an intent, pertaining to a query, by an automated conversational bot for providing human like responses to a user characterized by feeding a call recording archive to the automated conversational bot is disclosed. The program may comprise a program code for building, by a processor, an intent graph storing input dialogues, utterances, and output dialogues associated to an intent, wherein the intent indicates a context of a conversation between a caller and a call center representative, and wherein the intent graph is built by feeding each audio file indicating a call recording, present in a call recording archive, to a Natural Language Processing (NLP) engine in order to create a set of raw text transcripts pertaining to a category, determining a plurality of intents from the set of raw text transcripts upon identifying one or more NLP entities from words present in the set of raw text transcripts, wherein each intent is associated to at least one category, mapping the input dialogues, the utterances, and the output dialogues with each intent, of the plurality of intents thereby building the intent graph pertaining to each intent. The program may further comprise a program code for feeding, by the processor, training data, comprising the intent graph stored in the graph database, to an automated conversational bot by enabling a bot builder to fill a bot template associated to each intent with a set of parameters indicating distinct utterances of an intent and output dialogues associated to the distinct utterances. The program may further comprise a program code for training, by the processor, the automated conversational bot through reinforcement learning by providing a feedback to the automated conversational bot, wherein the automated conversational bot is trained by validating an output dialogue against an input dialogue, received from the caller, with an expected response, wherein the output dialogue is provided by the automated conversational bot based on the bot template and the training data thereby optimizing detection of the intent of a query by the automated conversational bot for providing human like responses to the user based on the call recording archive.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for optimizing detection of an intent, pertaining to a query, by an automated conversational bot for providing human like responses to a user, in accordance with an embodiment of the present subject matter.

FIG. 2 illustrates the system, in accordance with an embodiment of the present subject matter.

FIGS. 3 illustrates various components of the system, in accordance with an embodiment of the present subject matter.

FIG. 4 illustrates a method for optimizing detection of the intent by an automated conversational bot for providing human like responses to the user, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates to simplify and accelerate development of an automated conversational bot by feeding valuable corpus of audio files comprising call recordings archive to a system in order to provide human like responses to callers. Upon feeding the call recordings archive, the system cleanses each call recording in accordance with a requirements of a type of automated conversational bot (such as Alexa™, Slack™ Google™ Assistant, etc.). In one aspect, the system cleanses each call recording based on a set of filters. Examples of the set of filters may include, but not limited to, voice gender of the caller and the call center representative, language used in the call, the at least one category associated to the intent, and call duration.

Upon cleansing, each call recording may be fed into a Natural Language Processing (NLP) engine which is then read by the NLP engine to create a set of raw text transcripts pertaining to a recording category. For example, the recording category in Bank domain may include, but not limited to, New account, Existing customer, and Lost Card. Using the set of raw text transcripts, high-level NLP entities like Noun, Verbs, Question segment and Answer segment may be created. The set of raw text transcripts may then be processed to determine a plurality of intents from high-level NLP entities present in the set of raw text transcripts. Upon determination of the plurality of intents, each intent may be mapped with input dialogues, utterances, and output dialogues thereby building an intent graph pertaining to each intent and storing the intent graph in a graph database.

Once the intent graph is built, the intent graph may be fed into an automated conversational bot and enable a bot builder to fill in a bot template with a set of parameters with distinct utterances of an intent and output dialogues associated to the distinct utterances. It may be noted that intent graph is fed upon building a specific Bot script to bootstrap the development of the automated conversational bot by using specific templates and user configured actions such as invoke REST API or Lambda functions.

After feeding the intent graph, the automated conversational bot is trained by providing a feedback to the automated conversational bot. In other words, such building of the intent graph for a specific automated conversational bot assists the developer in testing the automated conversational bot using the raw text transcripts / audio files extracted from the call recordings archive. The aforementioned methodology may enable the developer in continuous tuning/training the automated conversational bot by feeding training data comprising the intent graph as part of the Machine learning model training purpose.

While aspects of described system and method for optimizing detection of the intent by the automated conversational bot for providing human like responses may be implemented in any number of different computing systems, environments, and/or configurations, the embodiments are described in the context of the following exemplary system.

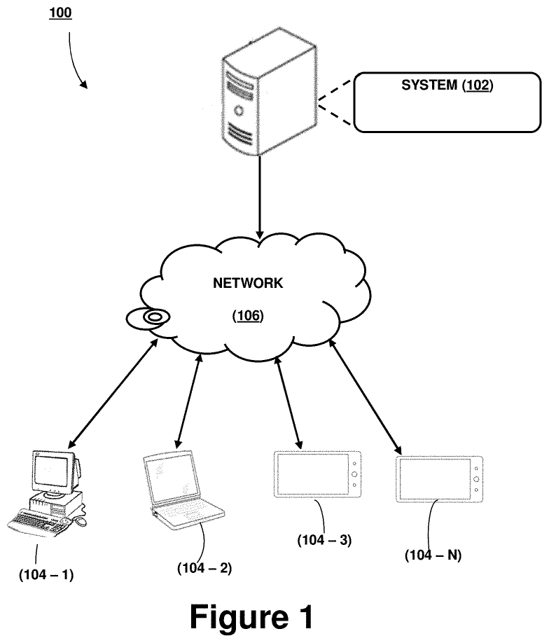

Referring now to FIG. 1, a network implementation 100 of a system 102 for optimizing detection of an intent, pertaining to a query, by an automated conversational bot for providing human like responses to a user is disclosed. The system 102 builds an intent graph storing input dialogues, utterances, and output dialogues associated to an intent. In one aspect, the intent may indicate a context of a conversation between a caller and a call center representative. The system further 102 feeds each audio file indicating a call recording, present in a call recording archive, to a Natural Language Processing (NLP) engine in order to create a set of raw text transcripts pertaining to a category. The system 102 further determines a plurality of intents from the set of raw text transcripts upon identifying one or more NLP entities from words present in the set of raw text transcripts. In one aspect, each intent may be associated to at least one category. The system 102 further maps the input dialogues, the utterances, and the output dialogues with each intent, of the plurality of intents thereby building the intent graph pertaining to each intent. The system 102 further feeds training data, comprising the intent graph stored in the graph database, to an automated conversational bot by enabling a bot builder to fill a bot template associated to each intent with a set of parameters indicating distinct utterances of an intent and output dialogues associated to the distinct utterances. The system 102 further trains the automated conversational bot through reinforcement learning by providing a feedback to the automated conversational bot. In one aspect, the automated conversational bot may be trained by validating an output dialogue against an input dialogue, received from the caller, with an expected response, wherein the output dialogue is provided by the automated conversational bot based on the bot template and the training data thereby optimizing detection of the intent of a query by the automated conversational bot for providing human like responses to the user based on the call recording archive.

Although the present disclosure is explained considering that the system 102 is implemented on a server, it may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a IoT device, IoT gateway, portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

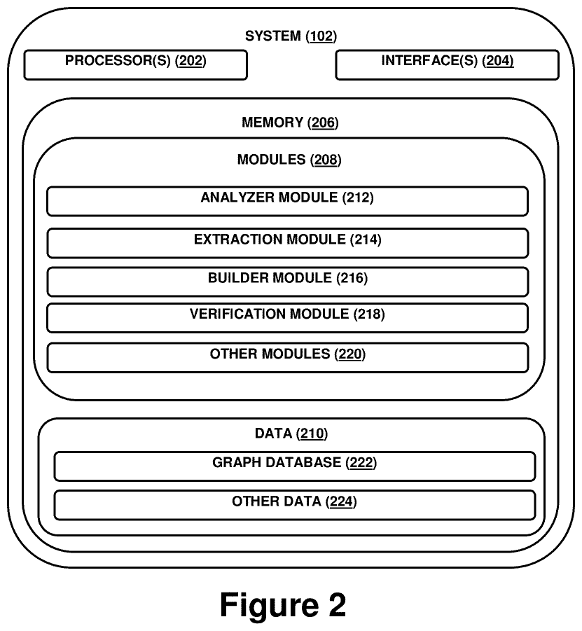

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an analyzer module 212, an extraction module 214, a builder module 216, a verification module 218, and other modules 220. The other modules 220 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a graph database 222 and other data 224. The other data 224 may include data generated as a result of the execution of one or more modules in the other modules 220.

As there are various challenges observed in the existing art, the challenges necessitate the need to build the system 102 for optimizing detection of an intent, pertaining to a query, by an automated conversational bot for providing human like responses to a user. In order to enable the automated conversational bot to provide human like responses to a user, at first, a user may use the user device 104 to access the system 102 via the I/O interface 204. The user may register them using the I/O interface 204 to use the system 102. In one aspect, the user may access the I/O interface 204 of the system 102. The system 102 may employ the analyzer module 212, the extraction module 214, the builder module 216, and the verification module 218. The detail functioning of the modules is described below with the help of figures.

It may be noted that a major process in developing the automated conversational bot is to detect the intent pertaining to a query and correct human like response for the intent outcome. As part of this process, a developer of the automated conversational bot has to think of various combinations and utterances of possible voice/chat inputs from end user for detecting the intent and its associated inputs. To an extent, the developer may embed of a limited set of possibilities of asking queries having similar intent. However, it may not be feasible for the developer to think all possible intent combinations and appropriate responses and embed the same into the automated conversational bot to provide the human like responses.

To overcome the aforementioned limitation, the system 102 uses a call recording archive comprising a corpus of real life conversations between callers and call center representatives. The call recording archive comprises a corpus of real life conversations for all possible intents. With the call recording archive, the system continuously trains the automated conversational bot by feeding the call recording archive that may be used to train the automated conversational bot in providing the human like responses. As a result of this, the developer may then focus on core intent actions instead of thinking about the Natural language part of the automated conversational bot.

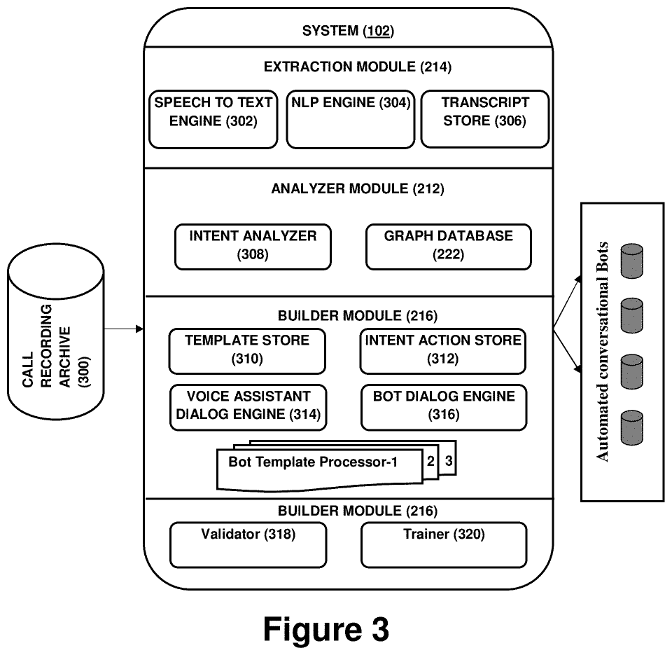

Further referring to FIGS. 2 and 3. To facilitate the above, the analyzer module 212 builds an intent graph storing input dialogues, utterances, and output dialogues associated to an intent based on the call recording archive 300 fed into the automated conversational bot. In one aspect, the intent indicates a context of a conversation between a caller and a call center representative.

In order to feed the call recording archive 300, the call recording archive 300 may be accessed from a distinct set of data sources. The distinct set of data sources may include, but not limited, Network Attached Storage (NAS), Storage Area Network (SAN), Object Storage, and File Servers. It may be noted that the call recording archive 300 from the aforementioned data sources may be accessed through one or more adapters for each of the above data sources. For example, NFS Client to access NFS shares, File System drivers to mount SAN block devices, REST Clients to access Object Storage such as AWS S3, and SCP/FTP Clients to access SCP/FTP based File servers. It may further be noted that each audio file containing the call recording is stored in a standard audio format such as WAV or MP3. The extraction module may use decoders for each file format to retrieved the conversation present in each audio file.

Upon decoding, each call recording present in the call recording archive 300 may be cleansed based on one or more filters. The one or more filters may include, but not limited to, voice gender of the caller and the call center representative, language used in the call, the at least one category associated to the intent, and call duration. It may be noted that each call recording may be cleansed to select an appropriate set of audio files as per the configuration of an automated conversational bot. In one embodiment, each call recording includes metadata for each call recorded and stores the data in following ways
1. As part of the Audio file (MP3/WAV headers)
2. Additional metadata file (JSON/XML)
3. Providing an API

The extraction module 214 extracts the metadata, stored as above, from each call recording by following methodologies respectively.
1. MP3/WAV file decoders to parse the metadata in audio file.
2. JSON/XML parsers to fetch the metadata from supplemental file for a given audio file.

3. API Clients to parse the data from HTTP header or Body.

Once the metadata is extracted, the metadata may be used against the filters to select the appropriate set of audio files as per the configuration of the automated conversational bot. Subsequent to the extraction of the metadata, the extraction module 214 fed each audio file, selected, to a Natural Language Processing (NLP) engine 304 in order to create a set of raw text transcripts pertaining to a category. In one example, the category in ‘Banking’ domain may include, but not limited to, New account, Existing customer, and Lost Card. It may be noted that the extraction module 214 creates the set of raw text transcripts from the appropriate set of audio files by using a speech to text engine 302 and then provided to the NLP engine 304 for further processing. Upon processing by the NLP engine 304, the set of raw text transcripts is stored in a transcript store 306.

Subsequently, the extraction module 214 further determines a plurality of intents from the set of raw text transcripts upon identifying one or more NLP entities from words present in the set of raw text transcripts. In one example, the extraction module 214 determines one or more intents from the set of raw text transcripts pertaining to a category, as follows. It may be understood that the category is a ‘Banking’
Case 1: Customer—Hi, I would like to know the balance of my checking
   Bot Response—Sure. Your balance as of today is XXX dollars
   Case 2: Customer—How much can I withdraw today?
   Bot Response—Let me Check. As of today the maximum cash you can withdraw is XXX Dollars

The intent in the above cases (1) and (2) is “Account Balance”.
Case 3: Customer—My ATM pin is not working. I am very frustrated
Bot Response—Sorry to hear that. Let me fix that for you
Case 4: Customer—I want to close my account since your ATM is not working
Bot Response—Thanks for the feedback. Please provide an opportunity to correct it for you

The intent in the above cases (3) and (4) is “ATM Complaint Intent”. From the above examples, it must be noted that each intent is associated to at least one category.

After the determination of the plurality of intents, the extraction module 214 maps the input dialogues, the utterances, and the output dialogues with each intent, of the plurality of intents thereby building the intent graph pertaining to each intent. In one aspect, the intent graph may be built by using a conceptual graph concept and stored in the graph database 222. The conceptual graph concept is used to implement Question and Answer systems for Fuzzy logic based AI model. In one embodiment, the input dialogues, the utterances, and the output dialogues may be mapped with each intent by using a WordNet Ontology.

In one embodiment, the analyzer module 212 further comprises an intent analyzer 308 which analyzes that what action needs to be taken for an intent that has been detected.

Once the intent graph is built, the builder module 216 feeds training data, comprising the intent graph stored in the graph database 222, to the automated conversational bot. The training data may be fed by enabling a bot builder to fill a specific bot template stored in a template store 310. The builder module 216 further comprises an intent action store 312. The intent action store 312 comprises mapping of action[s] that needs to be performed against the intent that has been detected by the intent analyzer 308. The builder module 216 further comprises a Voice Assistant Dialog Engine 314/a Bot Dialog Engine 316. In one aspect, both the Voice Assistant Dialog Engine 314/the Bot Dialog Engine 316 contain generic templates for the development of the automated conversational bot. Since each bot platform have their own format, the Voice Assistant Dialog Engine 314/the Bot Dialog Engine 316 are configured to convert the generic template to the Bot platform specific template.

Further it may be understood that each automated conversational bot has its own bot template that may be filled with a set of parameters. In one aspect, the set of parameters indicates distinct utterances of an intent and output dialogues associated to the distinct utterances. In an example of the bot template is mentioned as follows.

“resource”: {

“name”: “<#Name>”,
“version”: “<#Version>”,
“intents”: [
{

```
“name”: “<#IntentName>”,
“version”: “<#Version>”,
“fulfillmentActivity”: {
  “type”: “ReturnIntent”
},
“sampleUtterances”: [
  “#<Utterance1>”,
  “#<Utterance2>” ]
```

In order to fill the set of parameters in the bot template, as aforementioned, respective bot template processor-1, 2, 3 . . . , N of the builder module 216 queries the graph database 222 to retrieve possible strings including the output dialogues for the intent. In addition, the strings may also be queried using the “Potential Answer” query offered by the graph database 222, which in turn fetch all the possible answers matching the question related to intent.

Subsequent to the feeding of the training data, the automated conversational bot (such as Alexa™, Slack™, Google™ Assistant) is deployed on a test environment. The set of raw transcripts extracted is fed as the training data to the automated conversational bot and the output dialogue is validated against an expected response by a validator 318. If the response has anomalies, the expected response is fed again to train the automated conversational model. In other words, the verification module 218 enables a trainer 320 to train the automated conversational bot through a reinforcement learning method. The reinforcement learning method includes providing a feedback to the automated conversational bot by validating an output dialogue, against an input dialogue received from the caller, with an expected response. Over a period of time, the reinforcement learning makes the automated conversational bot to gradually learn from the feedback and enables the developer in continuous tuning/training the automated conversational bot by the feedback as part of the Machine learning model training purpose.

This, in this manner, the system 102 optimizes detection of the intent and thereby provides human like responses. In other words, the system 102 tests and trains the automated conversational bot using the set of raw text transcripts and audio from the call recording archives thereby attaining human like natural language processing including regional slangs and phrases.

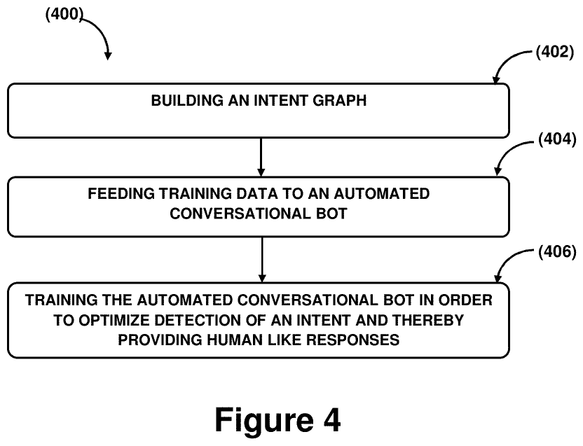

Referring now to FIG. 4, a method 400 for detection of an intent, pertaining to a query, by an automated conversational bot for providing human like responses to a user is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the system 102.

At block 402, an intent graph storing input dialogues, utterances, and output dialogues associated to an intent may be built. In one aspect, the intent indicates a context of a conversation between a caller and a call center representative. In one aspect, the intent graph is built by feeding each audio file indicating a call recording, present in a call recording archive, to a Natural Language Processing (NLP) engine in order to create a set of raw text transcripts pertaining to a category, determining a plurality of intents from the set of raw text transcripts upon identifying one or more NLP entities from words present in the set of raw text transcripts, wherein each intent is associated to at least one category, and mapping the input dialogues, the utterances, and the output dialogues with each intent, of the plurality of intents thereby building the intent graph pertaining to each intent. In one implementation, the intent graph may be built by the analyzer module 212.

At block 404, training data, comprising the intent graph stored in the graph database, may be fed to an automated conversational bot by enabling a bot builder to fill a bot template associated to each intent with a set of parameters indicating distinct utterances of an intent and output dialogues associated to the distinct utterances. In one implementation, the training data may be fed by the builder module 216.

At block 406, the automated conversational bot may be trained through reinforcement learning by providing a feedback to the automated conversational bot. In one aspect, the automated conversational bot may be trained by validating an output dialogue against, an input dialogue received from the caller, with an expected response. The output dialogue may be provided by the automated conversational bot based on the bot template and the training data. In one implementation, the automated conversational bot may be trained by the verification module 218.

Exemplary embodiments discussed above may provide certain advantages. Though not required to practice aspects of the disclosure, these advantages may include those provided by the following features.

Some embodiments enable a system and a method to assist bot developer in designing the possible input utterances for intent detection and intent inputs.

Some embodiments enable a system and a method to assist in forming human like responses for all possible intent responses including emotions and sentiments.

Some embodiments enable a system and a method to test and train the bot using a set of raw transcripts and audio from voice archives thereby attaining human like natural language processing including regional slangs and phrases.

Some embodiments enable a system and a method to reuse of existing contact center call recording archives instead of engaging in research to obtain input combinations thereby saving time in developing the bot with all possible utterances for intent detections.

Although implementations for methods and systems for optimizing detection of an intent, pertaining to a query, by an automated conversational bot for providing human like responses to a user sources have been described in language specific to structural features and/or methods, it is to be understood that the appended claims are not necessarily limited to the specific features or methods described. Rather, the specific features and methods are disclosed as examples of implementations for optimizing detection of the intent for providing human like responses to the user.

1. A method for optimizing detection of an intent, pertaining to a query, by an automated conversational bot for providing human like responses to a user characterized by feeding a call recording archive to the automated conversational bot, the method comprising:
building, by a processor, an intent graph storing input dialogues, utterances, and output dialogues associated to an intent, wherein the intent indicates a context of a conversation between a caller and a call center representative, and wherein the intent graph is built by,
feeding each audio file indicating a call recording, present in a call recording archive, to a Natural Language Processing (NLP) engine in order to create a set of raw text transcripts pertaining to a category,
determining a plurality of intents from the set of raw text transcripts upon identifying one or more NLP entities from words present in the set of raw text transcripts, wherein each intent is associated to at least one category, and
mapping the input dialogues, the utterances, and the output dialogues with each intent, of the plurality of intents thereby building the intent graph pertaining to each intent;
feeding, by the processor, training data, comprising the intent graph stored in the graph database, to an automated conversational bot thereby enabling a bot builder to fill a bot template pertaining to each intent with a set of parameters indicating distinct utterances of an intent and output dialogues associated to the distinct utterances; and
training, by the processor the automated conversational bot through reinforcement learning by providing a feedback to the automated conversational bot, wherein the automated conversational bot is trained by,
validating an output dialogue against an input dialogue, received from the caller, with an expected response, wherein the output dialogue is provided by the automated conversational bot based on the bot template and the training data
thereby optimizing detection of the intent of a query by the automated conversational bot for providing human like responses to the user based on the call recording archive.

2. The method as claimed in claim 1, wherein each call recording, present in the call recording archive, is fed to the NLP engine upon cleansing each audio file based on one or more filters, wherein the one or more filters comprises voice gender of the caller and the call center representative, language used in the call, the at least one category associated to the intent, and call duration.

3. The method as claimed in claim 1, wherein the intent graph is built by using a conceptual graph concept.

4. The method as claimed in claim 1, wherein the one or more NLP entities comprises noun, verbs, Question segment and Answer segment.

5. The method as claimed in claim 1, wherein the intent graph pertaining to each intent is stored in an intent graph database and wherein the set of parameters is filled in the bot template upon querying the intent graph database by the bot builder.

6. A system for optimizing detection of an intent, pertaining to a query, by an automated conversational bot for providing human like responses to a user characterized by feeding a call recording archive to the automated conversational bot, the system comprising:
a processor and
a memory coupled to the processor wherein the processor is capable of executing a plurality of modules stored in the memory and wherein the plurality of modules comprising:
an analyzer module for building an intent graph storing input dialogues, utterances, and output dialogues associated to an intent, wherein the intent indicates a context of a conversation between a caller and a call center representative, and wherein the intent graph is built by enabling an extraction module to
feed each audio file indicating a call recording, present in a call recording archive, to a Natural Language Processing (NLP) engine in order to create a set of raw text transcripts pertaining to a category,
determine a plurality of intents from the set of raw text transcripts upon identifying one or more NLP entities from words present in the set of raw text transcripts, wherein each intent is associated to at least one category, and
map the input dialogues, the utterances, and the output dialogues with each intent, of the plurality of intents thereby building the intent graph pertaining to each intent;
a builder module for feeding training data, comprising the intent graph stored in the graph database to an automated conversational bot by enabling a bot builder to fill a bot template associated to each intent with a set of parameters indicating distinct utterances of an intent and output dialogues associated to the distinct utterances; and
a verification module for training the automated conversational bot through reinforcement learning by providing a feedback to the automated conversational bot, wherein the automated conversational bot is trained by,
validating an output dialogue against, an input dialogue received from the caller, with an expected response, wherein the output dialogue is provided by the automated conversational bot based on the bot template and the training data,
thereby optimizing detection of the intent of a query by the automated conversational bot for providing human like responses to the user based on the call recording archive.

7. The system as claimed in claim 6, wherein each call recording, present in the call recording archive, is fed to the NLP engine upon cleansing each audio file based on one or more filters, wherein the one or more filters comprises voice gender of the caller and the call center representative, language used in the call, the at least one category associated to the intent, and call duration.

8. The system as claimed in claim 6, wherein the intent graph is built by using a conceptual graph concept.

9. The system as claimed in claim 6, wherein the one or more NLP entities comprises noun, verbs, Question segment and Answer segment.

10. The system as claimed in claim 6, wherein the intent graph pertaining to each intent is stored in an intent graph database and wherein the set of parameters is filled in the bot template upon querying the intent graph database by the bot builder.

11. A non-transitory computer readable medium embodying a program executable in a computing device for optimizing detection of an intent, pertaining to a query, by an automated conversational bot for providing human like responses to a user characterized by feeding a call recording archive to the automated conversational bot, the program comprising a program code:
a program code for building an intent graph storing input dialogues, utterances, and output dialogues associated to an intent, wherein the intent indicates a context of a conversation between a caller and a call center representative, and wherein the intent graph is built by,
feeding each audio file indicating a call recording, present in a call recording archive, to a Natural Language Processing (NLP) engine in order to create a set of raw text transcripts pertaining to a category,
determining a plurality of intents from the set of raw text transcripts upon identifying one or more NLP entities from words present in the set of raw text transcripts, wherein each intent is associated to at least one category, and
mapping the input dialogues, the utterances, and the output dialogues with each intent, of the plurality of intents thereby building the intent graph pertaining to each intent;
a program code for feeding training data, comprising the intent graph stored in the graph database to an automated conversational bot by enabling a bot builder to fill a bot template associated to each intent with a set of parameters indicating distinct utterances of an intent and output dialogues associated to the distinct utterances; and
a program code for training the automated conversational bot through reinforcement learning by providing a feedback to the automated conversational bot, wherein the automated conversational bot is trained by,
validating an output dialogue against an input dialogue, received from the caller, with an expected response, wherein the output dialogue is provided by the automated conversational bot based on the bot template and the training data,
thereby optimizing detection of the intent of a query by the automated conversational bot for providing human like responses to the user based on the call recording archive.
